(19) United States
(12) Patent Application Publication
(10) Pub. No.: US 2025/0209666 A1
(43) Pub. Date: Jun. 26, 2025

(54) METHOD OF NATIVELY PERFORMING PATTERN MATCHING/LOCATE OBJECT JOB SETUP ON IMAGING BASED DATA CAPTURE DEVICE USING AIMER

(71) Applicant: ZEBRA TECHNOLOGIES CORPORATION, Lincolnshire, IL (US)

(72) Inventor: Abhilash Gururaja, Levittown, NY (US)

(21) Appl. No.: 18/395,262

(22) Filed: Dec. 22, 2023

(51) Int. Cl. G06T 7/73; G06K 7/10; G06K 7/14; H04N 23/61; H04N 23/667

(52) U.S. Cl. CPC G06T 7/75; G06K 7/10722; G06K 7/1413; H04N 23/61; H04N 23/667

(57) ABSTRACT

Systems and methods are provided in which an imaging-based data capture device generates and updates its own object detection jobs. A job setup mode is entered directly on the imaging-based data capture device in response to a triggering event. Using an aiming pattern in a field of view, the device generates a model region corresponding to a portion of the image data. That model region is generated based on the position of the aiming pattern in the field of view. The device stores the model region in a job script, which it uses for pattern matching against images captured during a normal object scanning mode. Thus, the data capture device performs and deploys an entire object detection job setup sequence without using an external computer system or user interface software.

### BACKGROUND

Imaging-based data capture devices, including machine vision cameras, barcode readers, etc., have long been used to capture image data. Machine vision cameras, for example, are used in industrial automation assisting operators in a wide variety of tasks, such as tracking objects moving on conveyor belts. Often these machine vision cameras, along with the backend software, are used to capture a variety of parameters associated with the passing items. To do this, the software is configured with a job which includes a series of tools that are executing during each job execution. Subsequently, as items (e.g., boxes) pass within the field of view (FOV) of the camera, a job is executed for each such item.

Job creation can be a laborious process for these imaging-based data capture devices. Typically, a user positions a target object in a field of view of the capture device or positions the capture device so that its field of view includes the target object. Either way, the target must be within a field of view of the capture device when image data is captured. For a job that must include a barcode data capture tool, that means that the image data must include a barcode, for example. Still, even with the target captured, a user, through the backend software, manually identifies regions of interest in the captured image data, from which the backend software generates a model region for pattern matching. Through the manual interfacing with the backend software, the user defines the parameters necessary for the barcode data capture tool, for example. Only then, does the backend software deploy a job with the configured tool, e.g., having the model region manually established by the user. Even though it is beneficial to go through all these steps for generating jobs with tools that use pattern matching or locate object features, this job configuration process, which includes usage of a dedicated host computer, may not be always necessary to perform the same task.

Therefore, there is a need for a less computationally demanding and less time-consuming mechanism for configuring an imaging-based data capture device to create/run simple locate object jobs, without the need of configuring the capture device via an external computer system executing backend configuration software.

### SUMMARY

In an embodiment, the present invention is a method for generating an object detection job on a capture device, the method comprising: responsive to a triggering event at the data capture device, entering a job setup mode on the data capture device; generating, by an imaging-based data capture assembly in the data capture device, an aiming pattern and capturing image data of a field of view of the imaging-based data capture assembly where the image data includes the aiming pattern; determining, from the image data, a position of the aiming pattern within the image data; identifying, at the data capture device, a model region of the image data, the model region being identified, at least partially, based on the position of the aiming pattern; generating, at the data capture device, a model data corresponding to the model region, the model data being a subset of the image data; and storing the model data for access by a pattern matching process executable at the imaging-based data capture device during a job deployment mode on the data capture device.

In a variation of the current embodiment, the method further includes responsive to a subsequent triggering event at the data capture device, exiting the job setup mode and entering the job deployment mode of the data capture device. In another variation of the current embodiment, the method further includes: capturing at least one subsequent image data including the aiming pattern, for each of the at least one subsequent image data, determining a position of the aiming pattern within the subsequent image data, forming a plurality of positions of the aiming pattern; and identifying the model region of the image data based the plurality of positions of the aiming pattern. In yet more variations of the current embodiment, the method further includes generating, at the data capture device, at least one additional model data corresponding to the model region, the at least one additional model data having a different shape and/or position from the model data; and storing the model data and the at least one additional model data in a ranked manner for access by the pattern matching process.

In another embodiment, the present invention is a data capture device comprising: an imaging-based data capture assembly configured to capture image data over a field of view; one or more processors connected to the imaging assembly; and one or more memories storing instructions thereon that, when executed by the one or more processors, are configured to cause the one or more processors to: responsive to a triggering event at the imaging-based data capture device, enter a job setup mode on the imaging-based data capture device; generate, by the imaging-based data capture assembly, an aiming pattern and capture image data of a field of view of the imaging-based data capture assembly where the image data includes the aiming pattern; determine, from the image data, a position of the aiming pattern within the image data; identify, at the data capture device, a model region of the image data, the model region being identified, at least partially, based on the position of the aiming pattern; generate, at the data capture device, a model data corresponding to the model region, the model data being a subset of the image data; and store the model data for access by a pattern matching process executable at the data capture device during a job deployment mode on the imaging-based data capture device.

In a variation of the current embodiment, the instructions, when executed by the one or more processors further cause the one or more processors to, responsive to a subsequent triggering event at the data capture device, exit the job setup mode and enter the job deployment mode of the imaging-based data capture device. In more variations of the current embodiment, the instructions, when executed by the one or more processors, further cause the one or more processors to, in the job deployment mode, capture subsequent image data over the field of view, send the subsequent image data to the pattern matching process, and execute the pattern matching process to determine a match between the model data and the subsequent image data. In yet more variations of the current embodiment, the instructions, when executed by the one or more processors, further cause the one or more processors to, in the job deployment mode, determine a position of the aiming pattern in the subsequent image data and send the position of the aiming pattern in the subsequent image data to the pattern matching process. In even more variations of the current embodiment, the instructions, when executed by the one or more processors, further cause the one or more processors to, capture at least one subsequent image data including the aiming pattern, and for each of the at least one subsequent image data, determine a position of the aiming pattern within the subsequent image data, forming a plurality of positions of the aiming pattern, and identify the model region of the image data based the plurality of positions of the aiming pattern.

In another embodiment, a data capture device includes: an imaging-based data capture assembly operable to capture image data over a field of view (FOV); an aiming assembly configured to project an aiming pattern into the FOV; and a controller configured to: responsive to receiving a first trigger, cause the data capture device to operate in a first mode of operation where the data capture device (i) captures, via the imaging-based data capture assembly, first image data, (ii) based at least in part on a location of the aiming pattern within the first image data, determines a sub-region in the first image data, and (iii) store model data associated with the sub-region in the first image data in a memory associated with the data capture device.

In a variation of this embodiment, the controller is further configured to: responsive to receiving a second trigger, cause the data capture device to operate in a second mode of operation where the data capture device (i) captures, via the image-based data capture assembly, second image data, (ii) execute an image processing module on at least a portion of the second image data where the image processing module processes the at least the portion of the second image data based on the model data, and (iii) render an output to a host based, at least in part, on a result of the image processing module.

In another variation of this embodiment, the model data include object data related to a first feature present in the sub-region in the first image, and the image processing module is configured to identify a second feature in the at least the portion of the second image data based on the object data.

In another variation of this embodiment, the object data include image data of the first feature.

In another variation of this embodiment, the image processing module is configured to identify the second feature in the at least the portion of the second image data based on the object data by executing a pattern-matching algorithm to locate the second feature.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1A is a perspective view of an imaging-based data capture device in the form of a machine vision camera, in accordance with the teachings of this disclosure.

FIG. 1B illustrates a front perspective view of another example imaging-based data capture device, in the form of handheld barcode reader as an alternative example imaging device to that of FIG. 1A, in accordance with the teachings of this disclosure.

FIG. 1C illustrates a back perspective view of the handheld barcode reader of FIG. 1B.

FIG. 1D illustrates a back perspective view of the handheld barcode reader of FIG. 1B showing an aiming pattern in a field of view, in accordance with the teachings of this disclosure.

FIG. 1E is a perspective view of yet another imaging-based data capture device, in the form of presentation camera, in accordance with the teachings of this disclosure

FIG. 2 is a block diagram of an example logic circuit for implementing example methods and/or operations described herein.

FIG. 3 illustrates a flow diagram of an example method for generating an object detection job on an imaging-based data capture device such as any of devices shown in FIGS. 1A-1D, in accordance with the teachings of this disclosure.

FIGS. 4A-4E illustrated examples of captured image data, including image data containing aiming patterns and model region indicators, in accordance with the teachings of this disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally speaking, pursuant to these various embodiments, imaging-based data capture devices and methods are provided for generating an object detection job on the imaging-based data capture device, without needing to access an external computer system for job configuration. The object detection job may be a job that includes a tool that deploys pattern recognition or other similar tool operation to locate an object in captured image data. For example, these data capture devices may be configured to enter their own job setup mode in responsive to a triggering event at the data capture device. The data capture device may generate an aiming pattern and capture image data (having that aiming pattern) of a field of view thereof the. Without the need for an external computer system or even a display of the captured image data, the data capture device may nonetheless determine a position of the aiming pattern within the image data, automatically identify a sub-region of that image data such as particular a model region, based, at least partially, on the position of the aiming pattern, and generate model data corresponding to that identified sub-region. The data capture device can then store that model data in the form of a model region image data or data derived from the sub-region for access by a pattern matching process or other object identification process executing at the data capture device during a job deployment mode.

Thus, advantageously object detection jobs can be generated on and stored locally on imaging-based data capture devices, such as machine vision cameras, fixed cameras such as presentation scanners, handheld scanners such as barcode scanners, etc. without needing to access external computer systems running job configuration software. That is, the devices and methods herein reduce job configuration times, reduced computation load on resources, and remove the need for potentially error-prone manual job configuration steps. Further still, the devices and methods herein allow for updating stored jobs in a much more efficient and adaptive manner. Instead of requiring that an imaging-based data capture device be taken offline and connected to an external computer system for modifying, adding, and/or deleting jobs (or tools), with the present techniques a user can enter a job setup more directly on the barcode scanner and performing modification, addition, or deletion without substantial interruption to regular barcode scanning operations.

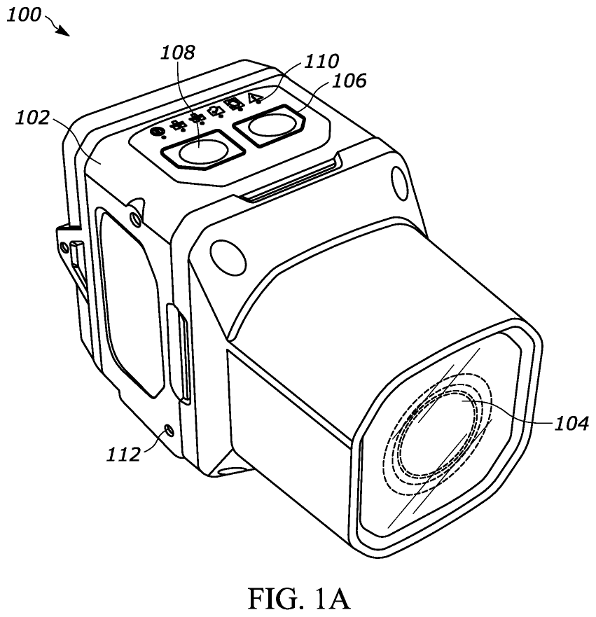

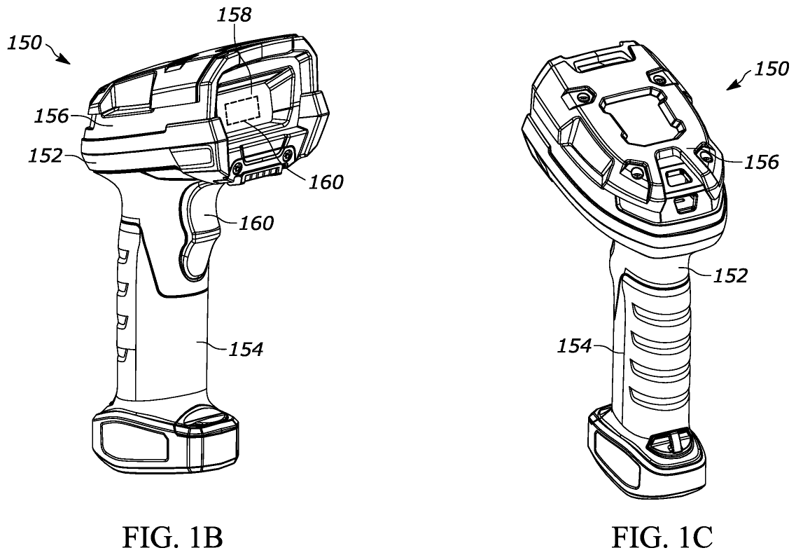

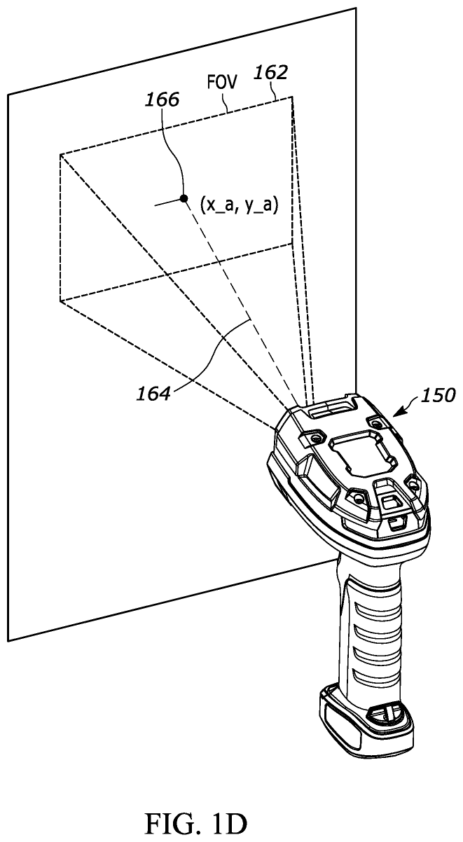

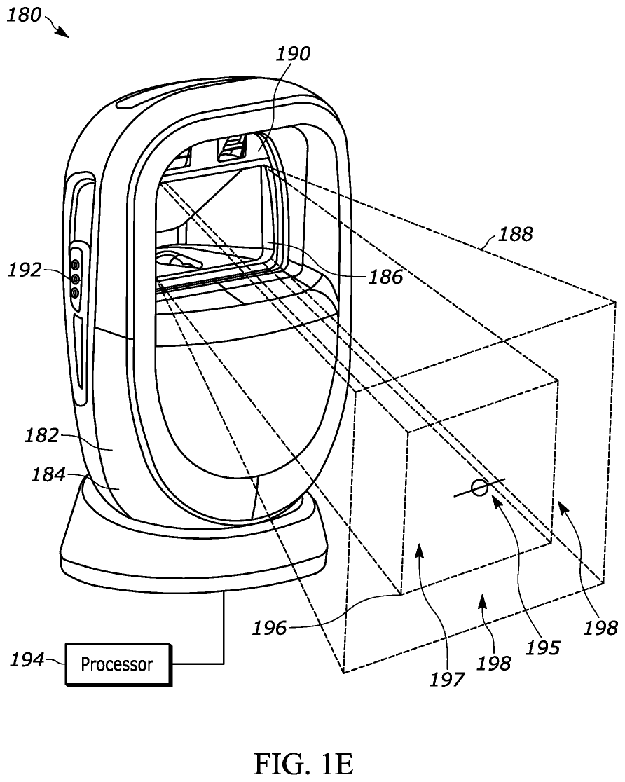

Referring to FIG. 1A, shown therein is an example data capture device 100 embodied in machine vision camera having an imaging-based data capture assembly, the components of which are now described. The capture device 100 is configured to perform one or more object detection job operations directly. In particular, the capture device 100 includes an aiming system configured to generate an aiming pattern (e.g., a dot, rectangle, circle, etc.) during a job deployment mode to assist a user in lining up a target for scanning, a target such as an indica on a label. As discussed further herein, that aiming system is also used during a job setup mode to assist in capture of a model region image data that the capture device 100 uses for pattern matching and/or object locating during that job deployment mode.

The capture device 100 may include a housing 102, an imaging aperture 104, a user interface label 106, a dome switch/button 108, one or more light emitting diodes (LEDs) 110, and/or mounting point(s) 112. In accordance with conventional operations, in some examples, the capture device 100 may obtain job files from an external user computing device, which the capture device 100 thereafter interprets and executes. The instructions included in the job file may include device configuration settings (also referenced herein as “imaging settings”) operable to adjust the configuration of the capture device 100 prior to capturing images of a target object. However, in accordance with the present teachings, the capture device 100 is configured to generate, modify, and/or deleting job files directly on the capture device 100 without resorting to connection to or receiving data from such external computing devices. The capture device 100 can therefore interpret and execute locally generated jobs along with jobs obtained from external sources. Examples herein are described with reference to some example jobs or tools, yet otherwise for object locating will become apparent and are intended to be covered herein.

While not shown, the capture device 100 includes one or one or more processors that are used to analyze and/or edit captured image data in accordance with the jobs stored in one or more memories in the capture device 100.

In the illustrated example, the capture device 100 includes a user interface label 106 that may include the dome switch/button 108 and one or more LEDs 110, and may thereby enable a variety of interactive and/or indicative features. Generally, the user interface label 106 may enable a user to trigger and/or tune to the capture device 100 (e.g., via the dome switch/button 108 that acts as a trigger) and to recognize when one or more functions, errors, and/or other actions have been performed or taken place with respect to the imaging capture device 100 (e.g., via the one or more LEDs 110). For example, the trigger function of a dome switch/button (e.g., dome/switch button 108) may enable a user to capture image data using the capture device 100 and/or to display a trigger configuration screen of a user application. A trigger configuration screen may allow the user to configure one or more triggers for the imaging device 104 that may be stored in one or more memories for use in later developed machine vision jobs, as discussed herein.

As another example, the tuning function of a dome switch/button (e.g., dome/switch button 108) may enable a user to automatically and/or manually adjust the configuration of the capture device 100 in accordance with a preferred/predetermined configuration and/or to display an imaging configuration screen of a user application. The imaging configuration screen may allow the user to configure one or more configurations of the captured device 100 (e.g., aperture size, exposure length, etc.) that may be stored in one or more memories for use in later developed machine vision jobs, as discussed herein.

Mounting point(s) 112 may enable a user connecting and/or removably affixing the capture device 100 to a mounting device (e.g., imaging tripod, camera mount, etc.), a structural surface (e.g., a warehouse wall, a warehouse ceiling, structural support beam, etc.), other accessory items, and/or any other suitable connecting devices, structures, or surfaces. For example, the capture device 100 may be optimally placed on a mounting device in a distribution center, manufacturing plant, warehouse, and/or other facility to image and thereby monitor the quality/consistency of products, packages, and/or other items as they pass through the capture device's 100 FOV. Moreover, the mounting point(s) 112 may enable a user to connect the capture device 100 to a myriad of accessory items including, but without limitation, one or more external illumination devices, one or more mounting devices/brackets, and the like.

In addition, the capture device 100 may include several hardware components contained within the housing 102 that enable connectivity to a computer network. For example, the capture device 100 may include a networking interface that enables the capture device 100 to connect to a network, such as a Gigabit Ethernet connection and/or a Dual Gigabit Ethernet connection. Further, the capture device 100 may include transceivers and/or other communication components as part of the networking interface to communicate with other devices via, for example, Ethernet/IP, PROFINET, Modbus TCP, CC-Link, USB 3.0, RS-232, and/or any other suitable communication protocol or combinations thereof.

Referring next to FIGS. 1B and 1C, illustrated therein is another exemplary data capture device. In particular, handheld data capture device 150 having an imaging-based data capture assembly, the components of which are now described. The data capture device 150 has a housing 152 with a handle portion 154, also referred to as a handle 154, and a head portion 156, also referred to as a scanning head 156. The head portion 156 includes a window 158 and is configured to be positioned on the top of the handle portion 154. The handle portion 154 is configured to be gripped by a reader user and includes a trigger 160 for activation by the user. Optionally included in an embodiment is also a base (not shown), also referred to as a base portion, that may be attached to the handle portion 154 opposite the head portion 156 and is configured to stand on a surface and support the housing 152 in a generally upright position. The handheld imaging device 150 can be used in a hands-free mode as a stationary workstation when it is placed on a countertop or other workstation surface. The handheld imaging device 150 can also be used in a handheld mode when it is picked up off the countertop or base station, and held in an operator's hand. In the hands-free mode, products can be slid, swiped past, or presented to the window 158 for the reader to initiate barcode reading operations. In the handheld mode, the barcode reader 150 can be moved towards a barcode on a product, and the trigger 160 can be manually depressed to initiate imaging of the barcode.

Other implementations may provide only handheld or only hands-free configurations. In the embodiment of FIGS. 1B and 1C, the handheld imaging device 150 is ergonomically configured for a user's hand, though other configurations may be utilized as understood by those of ordinary skill in the art. As shown, the lower handle 154 extends below and rearwardly away from the body 152 along a centroidal axis obliquely angled relative to a central FOV axis of a FOV of an imaging assembly within the scanning head 152.

As depicted in FIG. 1D, an aiming system 160 (e.g., an aiming light assembly) may be mounted in the handheld imaging device 150. That aiming system 160 may include an aiming light source and an aiming lens (optical pattern generator, etc.) for generating and directing a visible aiming light beam away from the handheld imaging device 150 onto the object in the direction of the FOV. In the illustrated example of FIG. 1D, a FOV 162 is shown having an imaging axis 164, within which an aiming light pattern 166 is generated. In the exemplary embodiment of FIG. 1D, the aiming light pattern 166 indicates the center of the FOV 162, namely the imaging axis 164. A position of the aiming light pattern 166 may be determined relative to a reference point or reference boundary of the FOV 162, as is indicated by coordinates (x_a, y_a) in the illustrated example. In particular, the aiming light pattern 166 bounds or surrounds the imaging axis 164, such that the aiming light is projected parallel to the imaging axis 164, though not colinear with the imaging axis 164. It will further be understood that the cross-sectional patterns depicted in FIG. 1D is not exclusive, and other patterns may be projected onto an imaging plane using the disclosed aim light assembly techniques.

FIG. 1E illustrates a perspective view of another example data capture device 180. The data capture device 180 may be referred to as a presentation scanner or barcode (indicia) reader and includes an imaging-based data capture assembly, as described. The capture device 180 may be handheld to move around a target to scan indicia or the capture device 180 may be stationary, for example, free standing on a countertop. While note shown, the capture device 180 includes an aiming assembly in accordance with techniques herein, and that aiming assembly is able to generate an aiming pattern in a FOV of the capture device 180.

In the example shown, the capture device 180 includes a housing 182 having a handle or a lower housing portion 184 and an optical imaging-based data capture assembly 186. The optical imaging assembly 186 is at least partially positioned within the housing 182 and has a FOV 188. The capture device 180 also includes an optically transmissive window 190 and a trigger 192. The optical imaging assembly 186 may include one or more image sensors that may include a plurality of photo-sensitive elements (e.g., visible photodetectors, infrared photodetectors or cameras, a color sensor or camera, etc.). The photo-sensitive elements may be arranged in a pattern and may form a substantially flat surface. For example, the photo-sensitive elements may be arranged in a grid or a series of arrays forming a 2D surface. The image sensor(s) of the optical imaging assembly 186 may have an imaging axis that extends through the window 190.

To operate the capture device 180, a user may engage the trigger 192 causing the capture device 180 to capture an image of a target, a product code, or another object. Alternatively, in some examples, the capture device 180 may be activated in a presentation mode to capture an image of the target, the barcode, or the other object. In presentation mode, a processor 194 is configured to process the one or more images captured by the optical imaging assembly 186 to identify a presence of a target, initiate an identification session in response to the target being identified, and terminate the identification session in response to a lack of targets in the FOV 188.

In the illustrated example, the capture device 180 also has an optional decode region 196 that is a sub-region of the FOV 188, where an aiming pattern 195 is generated by an aiming assembly within the capture device 180. The decode region 196 may be referred to as a first region 197 of the FOV 188, with a second region 198 of the FOV being the region of the FOV 188 that is not included in the first region 197. The capture device 180 may image a target in the first region 197 and the scanning device identifies and decodes indicia imaged in the first region 197. The capture device 180 also may further process decoded information of the indicia and provide information associated with the indicia to a user (e.g., via a user interface, monitor, tablet computer, handheld device, etc.) if the indicia is imaged within the first region 197. If the indicia is imaged in the second region 198 the processor may not decode the indicia, as the second region 198 is outside of the decode region 196. In examples where the indicia is imaged in the second region 198, the processor may decode information associated with the indicia, but may not further provide the information to a user or another system for further processing.

The imaging-based data capture devices herein include one or more light-detecting sensors or imagers operatively coupled to, or mounted on, a printed circuit board (PCB). For example, the machine vision camera 100, the handheld imaging device 150, and presentation scanner 180 may each include a PCB mounted therein. In further embodiments, an illuminating light assembly may also be mounted in the machine vision camera 100, handheld imaging device 150, and the presentation scanner 180, etc. The illuminating light assembly may include an illumination light source and at least one illumination lens, configured to generate a substantially uniform distributed illumination pattern of illumination light on and along an object to be read by image capture.

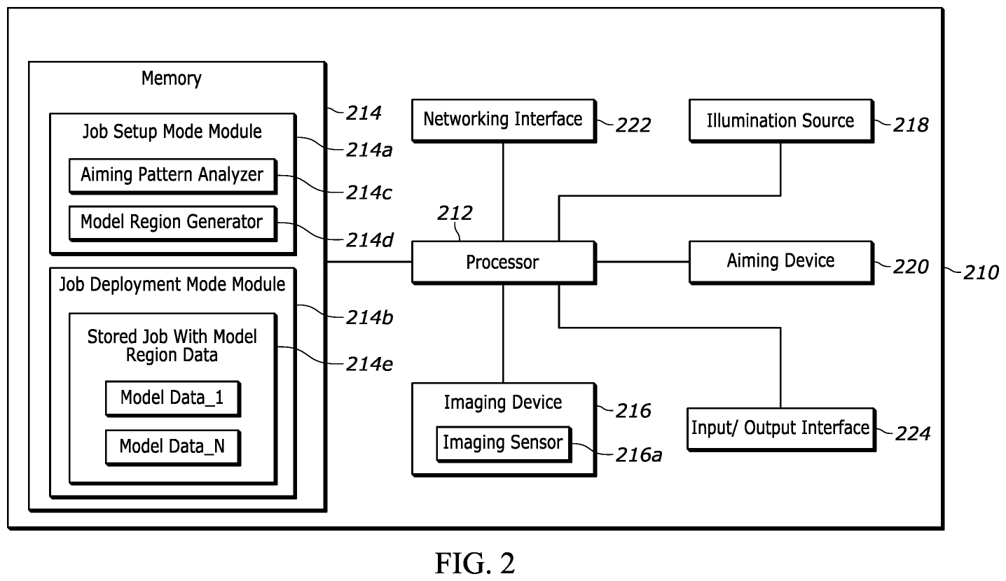

Each of the machine vision camera 100, the handheld imaging device 150, and presentation scanner 180 includes logic circuitry for operating the respective device in both a job setup mode and a job deployment mode. A block diagram of an example logic circuit for use in either imaging-based data capture device 100, 150, or 180 is shown in FIG. 2. The logic circuit is capable of implementing, for example, one or more components of the example systems and methods described herein. The example logic circuit of FIG. 2 is a processing platform 210 capable of executing instructions to, for example, implement operations of the example methods described herein, as may be represented by the flowcharts of the drawings that accompany this description. Other example logic circuits capable of, for example, implementing operations of the example methods described herein include field programmable gate arrays (FPGAs) and application specific integrated circuits (ASICs).

The example processing platform 210 of FIG. 2 includes a processor 212 such as, for example, one or more microprocessors, controllers, and/or any suitable type of processor. The example processing platform 210 of FIG. 2 includes memory (e.g., volatile memory, non-volatile memory) 214 accessible by the processor 212 (e.g., via a memory controller). The example processor 212 interacts with the memory 214 to obtain, for example, machine-readable instructions stored in the memory 214 corresponding to, for example, the operations represented by the flowcharts of this disclosure. Additionally, or alternatively, machine-readable instructions corresponding to the example operations described herein may be stored on one or more removable media (e.g., a compact disc, a digital versatile disc, removable flash memory, etc.) that may be coupled to the processing platform 210 to provide access to the machine-readable instructions stored thereon.

As an example, the example processor 212 may interact with the memory 214 to access and execute instructions related to and/or otherwise having a job setup mode module 214a and a job deployment mode module 214b. The job setup mode module 214a, as described in examples further below, may include an aiming pattern analyzer 214c and a model region image data generator 214d that execute during a job setup mode. The job deployment mode module 214b includes, among other instructions not shown, jobs 214e generated by the job setup mode module 214c during the job setup mode. These jobs 214e may include model data to be used in pattern matching or other object identification during analysis of image data captured by the imaging device 216 during the job deployment mode, e.g., during scanning of objects as part of a POS operation or other barcode scanning operation. The model data may include the model region image data such as an image of the model region itself, coordinate data for the model region, image feature data, and/or other data for pattern matching and/or object location during scanning operation. Thus, the model data may be in the form of data associated with the model region image, i.e. data obtained from the model region image. For example, the model region image may be transformed into a reduced data (such as downsampled image data, vector data, serialized data, etc.) that is stored in memory and used for analysis of subsequent images. While the jobs 214e are illustrated as stored on the memory 214, in other examples, jobs 214e may be stored in memories associated with the data capture device, including memories external to the housing of the capture device.

As illustrated in FIG. 2, an imaging device 216 includes imaging sensor(s) 216a. The imaging sensor(s) 216a may include one or more sensors configured to capture image data corresponding to a target object, an indicia associated with the target object, and/or any other suitable image data. The imaging sensor(s) 216a may be or include a barcode scanner with one or more barcode imaging sensors that are configured to capture one or more images of an indicia associated with the target object.

The processing platform 210 may further include an illumination source 218 generally configured to emit illumination during a predetermined period in synchronization with image capture of the imaging device 216. The imaging device 216 may be configured to capture image data during the predetermined period, thereby utilizing the illumination emitted from the illumination source 218.

The processing platform 210 may further include an aiming assembly 220. The aiming assembly 220 may be an aiming light assembly mounted in, attached to, or associated with the imaging-based data capture device and includes an aiming light source, e.g., one or more aiming LEDs or laser light sources, and optionally an aiming lens, aiming pattern generator, etc. for generating and directing a visible aiming light beam away from the imaging-based data capture device onto object in a FOV. It will be understood that, although the aiming assembly 220 and the illumination source 218 both provide light, an aiming light assembly differs from the illumination light assembly at least in the type of light the component provides. For example, the illumination source 218 provides diffuse light to sufficiently illuminate an object and/or an indicia of the object (e.g., for image capture). The aiming assembly 220 instead provides a defined illumination pattern (e.g., to assist a user in visualizing some portion of the FOV).

The example processing platform 210 in FIG. 2 also includes a network interface 222 to enable communication with other machines via, for example, one or more networks. The example network interface 222 includes any suitable type of communication interface(s) (e.g., wired and/or wireless interfaces) configured to operate in accordance with any suitable protocol(s). For example, in some embodiments, networking interface 220 may transmit data or information (e.g., imaging data and/or other data described herein) between the processing platform 210 and any suitable connected device(s).

The example, processing platform 210 of FIG. 2 also includes input/output (I/O) interfaces 224 to enable receipt of user input and communication of output data to the user.

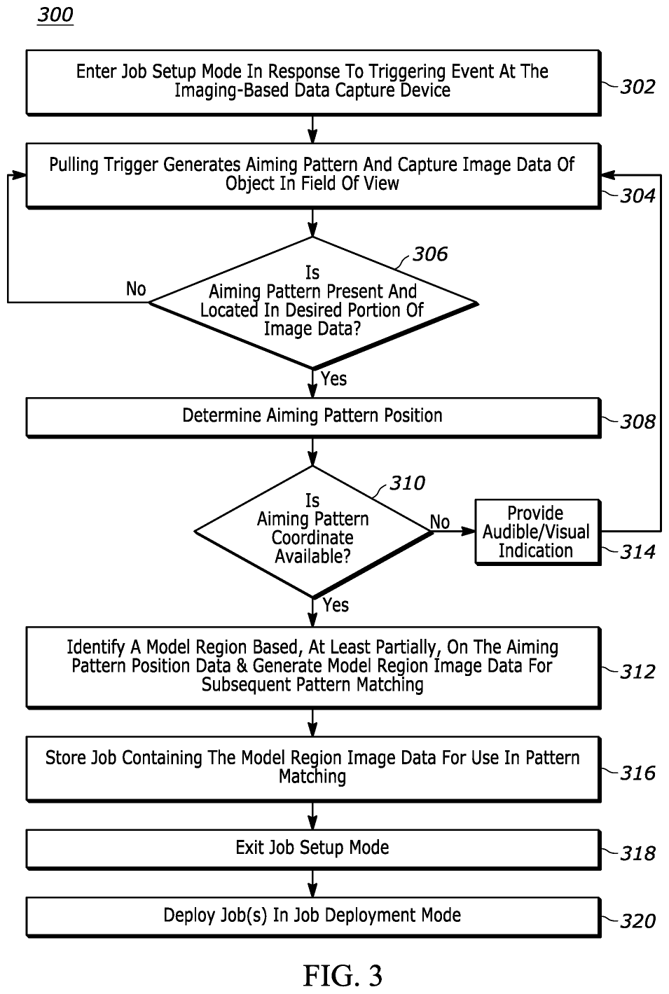

Referring next to FIG. 3, method 300 illustrates a flow diagram of an example method for generating an object detection job on an imaging-based data capture device, such as, for example the device 100 in FIG. 1A and the device 150 in FIGS. 1B-1D. Although the method 300 is, for example purposes, described below with regard to the imaging-based data capture device 150 and components thereof as illustrated in FIG. 2, it will be understood that other similarly suitable imaging devices and/or components may be used instead.

At block 302, the imaging-base data device 150 enters a job setup mode in response to a trigger event. In various examples, the triggering event occurs at the device 150. The triggering event may result from capturing particular image data by the imaging device 216, such as capturing image data of a particular barcode or other indicia that, when decode at the device 150 instructs the device 150 to enter the job setup mode. Triggering events may be a unique button sequence such as long press, double press of button, etc. of the trigger 160.

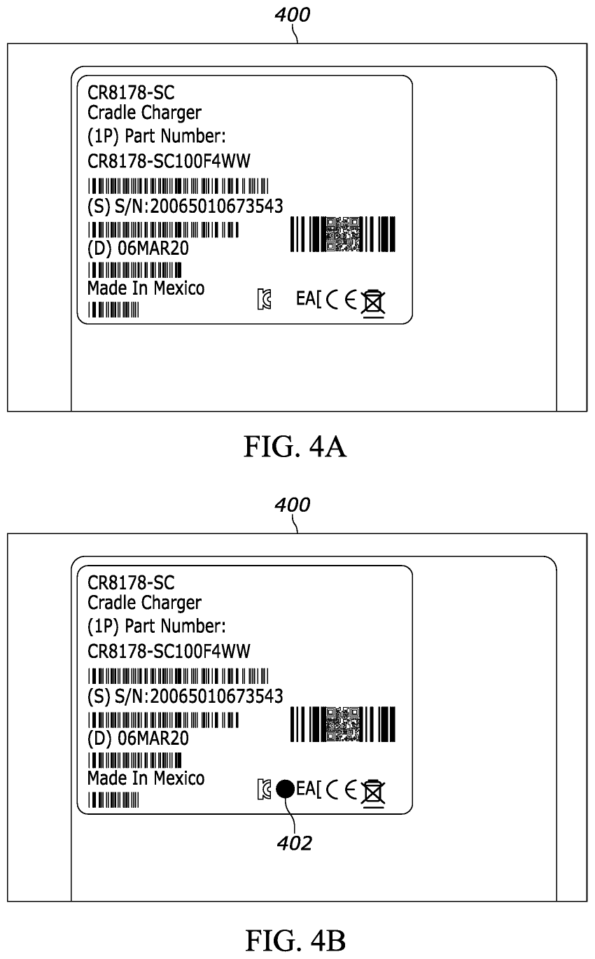

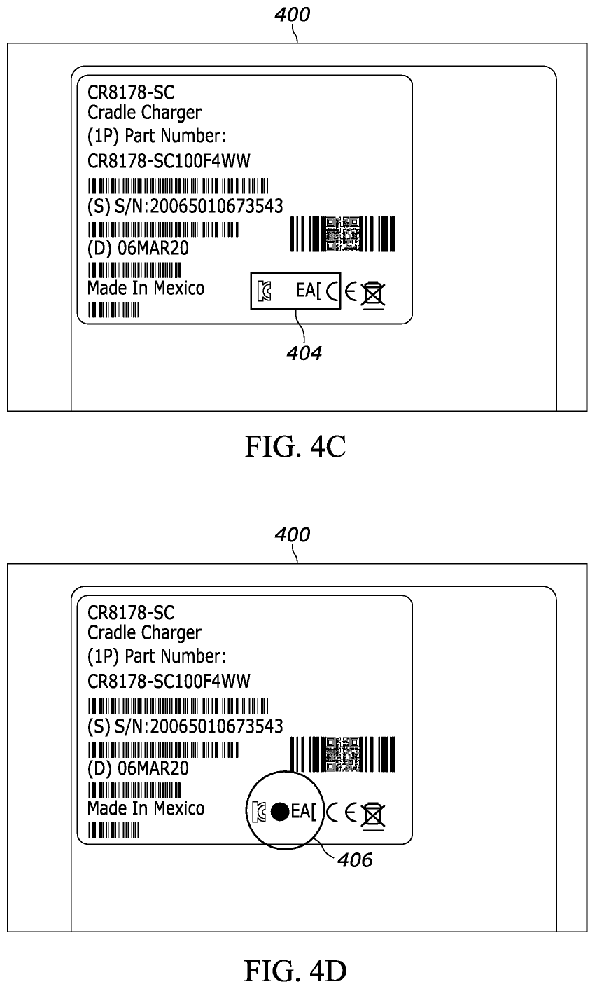

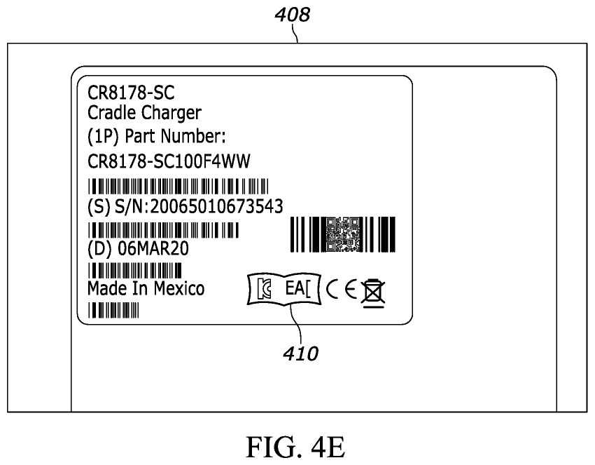

Whether responsive to entering the job setup mode or already in the job setup mode, at a block 304, the device 150 generates an aiming pattern, using the aiming assembly 220, and captures image data of a FOV of the device 150, using the imaging device 216, where the image data is to include the aiming pattern. In the illustrated example, the method 300 analyzes the image data to determine (at block 306) whether the aiming pattern was in the captured image data. In particular, in some examples, the method 300 determines wherein the aiming pattern coincides with a particular object or feature, within the image data. For example, during a job setup mode, the aiming pattern analyzer 214c may determine whether the aiming pattern coincides with a particular portion of a label captured in the image data, as discussed further in reference to FIGS. 4A-4E. If the aiming pattern in the captured image data does not meet the desired requirements of block 306 control is returned to block 304 for capturing new image data.

In various examples, at the block 304, the method 300 captures a plurality of image frames in response to the trigger pull. These may be frames of image data captured during the trigger pull or a predetermined number of frames capture in response to detection of the trigger pull. The number frames of image data capture may determine on acquisition settings of the imaging-based capture device. In some such examples, the block 304 may selectively turn “ON” the aiming pattern so that the aiming pattern is visible for use by the blocks 306 and 308 in identifying the aiming pattern and determining a position of the aiming pattern relative to the image data acquired on those frames. The block 304 may also selectively turn “OFF” the aiming pattern for other frames, so that the aiming pattern is not visible in other frame. For example, it may be desirable to not have the aiming pattern appear in the sub-region identified at block 312. That is, the block 304 may capture, as image data, different image frames where at least one frame includes the aiming pattern and where at least one frame does not include the aiming pattern. Such selective image frame capture allows the blocks 306 and 308 to analyze image frames with the aiming pattern, while the block 312 takes the aiming pattern data obtained from these images and then analyzes images without the aiming pattern to generate the model region for using in pattern matching via the jobs created at block 316.

At a block 308, executed by the aiming pattern analyzer 314c, the device 150 determines a position of the aiming pattern within the image data, for example, by determining pixel coordinates (x_a, y_a) of a center portion of the aiming pattern relative to a reference position or reference frame of the imaging sensor 216a. In some examples, the position of the aiming pattern is determined from a single image data. While in other examples, a plurality, n, of image data may be captured at the block 304 and the position of the aiming pattern may be taken as an average over, n, frames of image data. The method 300 determines (at block 310), if the aiming pattern position is determined and passes control to a block 312 if so, otherwise control is passed to a block 314 which provides an audible and/or visual indication at device 150 so that user knows of the failed attempt during the job setup mode. Block 314 passes control back to block 304 for capturing new image data in response to a new trigger pull, for example.

At the block 312, as may be implemented by the model region generator 214d, the method 300 takes the aiming position data and identifies a sub-region of the image data in the form of a model region, where that the model region is identified, at least partially, based on the position of the aiming pattern. The block 312 then generates a model data corresponding to that model region, where that model data is used for pattern matching and/or object location in a job generated and stored at block 316. That model data may be the model region image data or data derived therefrom, as described. The block 316, for example, generates a job containing the model data storing it at data 214e. The model data may be of a default data size, large enough to store data for sufficient pattern matching and/or object location. But it is recognized that the data size may be configured of smaller or larger sizes depending on the model region, the number of model regions, the size of the imaging sensor, etc.

These processes of the method 300 are described in reference to FIGS. 4A-4D. FIG. 4A illustrates initial image data 400 captured, for example, at block 302 in response to entry into a job setup mode. FIG. 4B illustrates image data 400 with an aiming pattern 402 that is generally centrally positioned within the FOV of the imaging device. FIG. 4C illustrates a model region 404 that has been determined at block 312 based, at least partially, on the position of the aiming pattern 402. In the example of FIG. 4C, the block 312 has been configured to generate a model region in the form of rectangular shaped image data centered on the aiming pattern and coinciding with a subset of the entire image data 400. FIG. 4D illustrates another example model region 406 generated by the block 312 when configured to generate the model region in the form of a circular shaped image data centered on the aiming pattern. The shape, position, and size of the model region may be of any suitable variation to be used in pattern matching during barcode scanning in the job deployment mode. Further, the shape, position, and size of the model region may be predetermined and stored in the job scripts 214e. Generally, the model region will have a geometric shape.

After the model data from the block 312 is stored in a job at block 316, the process 300 exits the job setup mode at block 318 and places the imaging device 150 into the job deployment mode at block 320. In the job deployment, jobs stored at data 214e are accessed and used for pattern matching against subsequently captured image data.

In the job deployment mode, subsequently captured image data is provided to a pattern matching process (e.g., within the module 214b) where the imaging device examines that image data for the presence of a portion that matches the model data determined in the job setup mode.

In some examples, in addition to doing pattern matching, the job deployment mode module 214b with also identify an aiming pattern in the subsequent image data and determine a position of the aiming pattern and use the resulting position data to assist the pattern matching process. For example, the processing platform 210 may first determine a position of an aiming pattern and then look for the model data contained in the one more job scripts 214e determine more quickly whether the subsequent image data contains a desired image pattern. In yet further examples, in the job deployment mode, the processing platform 210 may perform preliminary image processing on the subsequently captured image data prior to sending that image data to a pattern matching process of the module 214b. This preliminary image processing may include feature detection or an optical character recognition operations being performed on the image data.

Various alternatives to the operations described in method 300 are contemplated. For example, the block 312 may be configured to generate a plurality of different model regions, each different from another in geometric shape and/or position, for example. In this way, the block 316 could store multiple different model regions, in a single job or in multiple jobs 214e, for use in pattern matching during the job deployment mode. In the example of FIG. 2, multiple ranked model data are shown, labeled “MODEL DATA_1” through “MODEL DATA_N”. For example, the model region 404 may be stored along with a similarly shaped smaller rectangular model region and similarly shaped larger rectangular model region. Generating multiple different model regions may allow the job deployment module 214b to use different model regions for pattern matching in different scenarios. For example, depending on image features identified in image data, it may be that the barcode in image data is closer or further away from the imaging device 216, i.e., consuming a larger or smaller portion of the image sensor, such that a particular model region size may be more efficient in more quickly performing pattern matching.

In yet other examples, the processes of block 304, 318, and block 312 may be implemented to capture a plurality of image data, each image data captured in response to a different trigger pull, and the aiming pattern position is determined for each image data. In such configurations, the block 312 may be configured to generate a model region that is variable and determined from the multiple different aiming pattern positions. For example, a first aiming pattern position may be stored at the block 312, for a first image data. A second aiming pattern position may be stored at the block 321, for a second image data. And so on. The block 312 may then generate a model region that incorporates each of these aiming pattern positions. FIG. 4E illustrates an example image data 408 and a model region 410 that is generated after analyzing a plurality of aiming pattern positions determined across a plurality of captured images frames. Thus, in some examples, the user can affect the determined model region shape and size by capturing a series of images with the aiming pattern pointed in series of different positions.

Thus, as described, in various implementations, a plurality of model data may be stored in the data 214e. These model data may be stored in different job or in a single job. Further the plurality of model region image data may be stored in a ranked manner, such that they used in a particular order when performing pattern matching during the job deployment mode.

The above description refers to a block diagram of the accompanying drawings. Alternative implementations of the example represented by the block diagram includes one or more additional or alternative elements, processes and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A method generating an object detection job on a capture device, the method comprising:
responsive to a triggering event at the data capture device, entering a job setup mode on the data capture device;
generating, by an imaging-based data capture assembly in the data capture device, an aiming pattern and capturing image data of a field of view of the imaging-based data capture assembly where the image data includes the aiming pattern;
determining, from the image data, a position of the aiming pattern within the image data;
identifying, at the data capture device, a model region of the image data, the model region being identified, at least partially, based on the position of the aiming pattern;
generating, at the data capture device, a model data corresponding to the model region, the model data being a subset of the image data; and
storing the model data for access by a pattern matching process executable at the imaging-based data capture device during a job deployment mode on the data capture device.

2. The method claim 1, further comprising: responsive to a subsequent triggering event at the data capture device, exiting the job setup mode and entering the job deployment mode of the data capture device.

3. The method of claim 2, further comprising, in the job deployment mode, capturing subsequent image data over the field of view, sending the subsequent image data to the pattern matching process, and executing the pattern matching process to determine a match between the model data and the subsequent image data.

4. The method of claim 3, further comprising, in the job deployment mode, determining a position of the aiming pattern in the subsequent image data, and sending the position of the aiming pattern in the subsequent image data to the pattern matching process.

5. The method of claim 3, further comprising, in the job deployment mode, performing image processing on the subsequent image data prior to sending the subsequent image data to the pattern matching process, the image processing comprising a feature detection or an optical character recognition.

6. The method of claim 1, wherein the model region is centered on the position of the aiming pattern.

7. The method of claim 1, wherein the model region has a geometric shape.

8. The method of claim 1, further comprising:
capturing at least one subsequent image data including the aiming pattern;
for each of the at least one subsequent image data, determining a position of the aiming pattern within the subsequent image data, forming a plurality of positions of the aiming pattern; and
identifying the model region of the image data based the plurality of positions of the aiming pattern.

9. The method of claim 1, wherein generating the model data corresponding to the model region comprises performing an image processing on at least a portion of the image data, the image processing comprising a feature detection or an optical character recognition.

10. The method of claim 1, wherein the position of the aiming pattern is determined relative to an imaging sensor of the imaging-based data capture device.

11. The method of claim 1, wherein determining the position of the aiming pattern within the image data comprises: identifying a feature in the image data and determining the position of the aiming data relative to the feature.

12. The method of claim 1, further comprising generating, at the data capture device, at least one additional model data corresponding to the model region, the at least one additional model data having a different shape and/or position from the model data; and storing the model data and the at least one additional model data in a ranked manner for access by the pattern matching process.

13. A data capture device comprising:
an imaging-based data capture assembly configured to capture image data over a field of view;
one or more processors connected to the imaging assembly; and
one or more memories storing instructions thereon that, when executed by the one or more processors, are configured to cause the one or more processors to:
responsive to a triggering event at the imaging-based data capture device, enter a job setup mode on the imaging-based data capture device;
generate, by the imaging-based data capture assembly, an aiming pattern and capture image data of a field of view of the imaging-based data capture assembly where the image data includes the aiming pattern;
determine, from the image data, a position of the aiming pattern within the image data;
identify, at the data capture device, a model region of the image data, the model region being identified, at least partially, based on the position of the aiming pattern;
generate, at the data capture device, a model data corresponding to the model region, the model data being a subset of the image data; and
store the model data for access by a pattern matching process executable at the data capture device during a job deployment mode on the imaging-based data capture device.

14. The device of claim 13, wherein the instructions, when executed by the one or more processors, further cause the one or more processors to:
responsive to a subsequent triggering event at the data capture device, exit the job setup mode and enter the job deployment mode of the imaging-based data capture device.

15. The device of claim 14, wherein the instructions, when executed by the one or more processors, further cause the one or more processors to:
in the job deployment mode, capture subsequent image data over the field of view, send the subsequent image data to the pattern matching process, and execute the pattern matching process to determine a match between the model data and the subsequent image data.

16. The device of claim 15, wherein the instructions, when executed by the one or more processors, further cause the one or more processors to:
in the job deployment mode, determine a position of the aiming pattern in the subsequent image data and send the position of the aiming pattern in the subsequent image data to the pattern matching process.

17. The device of claim 15, wherein the instructions, when executed by the one or more processors, further cause the one or more processors to:
in the job deployment mode, perform image processing on the subsequent image data prior to sending the subsequent image data to the pattern matching process, the image processing comprising a feature detection or an optical character recognition.

18. The device of claim 13, wherein the instructions, when executed by the one or more processors, further cause the one or more processors to: center the model region on the position of the aiming pattern.

19. The device of claim 13, wherein the instructions, when executed by the one or more processors, further cause the one or more processors to:
capture at least one subsequent image data including the aiming pattern;
for each of the at least one subsequent image data, determine a position of the aiming pattern within the subsequent image data, forming a plurality of positions of the aiming pattern; and
identify the model region of the image data based the plurality of positions of the aiming pattern.

20. The device of claim 13, wherein the instructions, when executed by the one or more processors, further cause the one or more processors to:
generate the model data corresponding to the model region by performing an image processing on at least a portion of the image data, the image processing comprising a feature detection or an optical character recognition.

21. The device of claim 13, wherein the instructions, when executed by the one or more processors, further cause the one or more processors to:
determine the position of the aiming pattern is relative to an imaging sensor of the imaging assembly.

22. The device of claim 13, wherein the instructions, when executed by the one or more processors, further cause the one or more processors to:
identify a feature in the image data and determine the position of the aiming data relative to the feature.

23. The device of claim 13, wherein the instructions, when executed by the one or more processors, further cause the one or more processors to:
generate, at the data capture device, at least one additional model data corresponding to the model region, the at least one additional model data having a different shape and/or position from the model data; and
store the model data and the at least one additional model data in a ranked manner for access by the pattern matching process.

24. The device of claim 23, wherein the instructions, when executed by the one or more processors, further cause the one or more processors to: utilize, based on the ranked manner of the model data and the at least one additional model data, a desired model data for use during job deployment mode of the imaging-based data capture device.

25. The device of claim 13, wherein the imaging assembly is a barcode reader.

26. The device of claim 13, wherein the imaging assembly is a machine vision camera.

27-36. (canceled)
